(19) United States
(12) Patent Application Publication
(10) Pub. No.: US 2004/0129908 A1
(43) Pub. Date: Jul. 8, 2004

(54) Valve assembly

(76) Inventor: Andries Matthys Booyens, Pretoria (ZA)

Correspondence Address: Slifer Polglaze Leffert & Jay, PO Box 581009, Minneapolis, MN, 55458-1009, US

(21) Appl. No.: 10/221,472

(22) PCT Filed: Mar. 12, 2001
(86) PCT No.: PCT/ZA01/00031

(30) Foreign Application Priority Data
Mar. 13, 2000 (ZA) 2000/1273

(51) Int. Cl. F16K 31/165

(52) U.S. Cl. 251/61.2

(57) ABSTRACT

The invention provides a valve assembly (10) including a valve body (12) defining a passage (14) having an inlet (16) and an outlet (18), the body having a valve seat (20); and a valve member for opening and closing the passage, the valve member being movable relative to the body between an open position, and a closed position wherein the valve member seals against the valve seat. The valve assembly also includes an actuator assembly (28) for moving the valve member between the open and closed positions, the actuator assembly including a shaft (30) movable relative to the body and connected to the valve member, and two primary pressure chambers (32, 34). The primary chambers are divided into a relatively high-pressure chamber (32.2, 34.2) and a relatively low-pressure chamber (32.1, 34.1) by movable sealing means connected to the shaft. The arrangement is such that pressurisation of the relatively high-pressure chambers moves the valve member towards the closed position.

### INTRODUCTION AND BACKGROUND TO THE INVENTION

This invention relates to a valve assembly. More particularly but not exclusively this invention relates to a relatively high-pressure, relatively high flow-rate, large capacity, valve assembly suitable for regulating flow along a large capacity, high-velocity and pressure liquid supply line.

Various valve assemblies for regulating primary and secondary liquid supply lines are known. For example, a number of valve assemblies are disclosed in the specifications of U.S. Pat. Nos. 3,670,771; 3,760,845; 5,395,090; and 5,460,198. These valves all suffer from one disadvantage or the other.

For example, the valve assembly disclosed in U.S. Pat. No. 5,395,090 suffers from the disadvantage that it allows only a limited flow rate through the valve body, because the inlet to and the outlet from the valve body are not aligned, and the liquid is thus deflected through 90 degree turns inside the valve body. This causes additional head losses, cavitation and rapid wear of the valve components at high flow velocity and consequential high differential pressure conditions.

Furthermore, by having only one pressure control chamber, the design thereof is invariably relatively large and bulky to provide a sufficient closing surface advantage, necessary to oppose the opening force of the up-stream pressure. Because the pressure control chamber is disposed in the flow path inside the valve body, the flow path is restricted and not sufficiently streamlined. The differential pressure conditions and flow-rates at which the valves of this type can be used are therefore limited.

### OBJECT OF THE INVENTION

It is therefore an object of the present invention to provide a valve assembly with which the aforesaid disadvantages can be overcome or at least minimised and to provide a useful alternative to the known valves.

### SUMMARY OF THE INVENTION

According to the invention there is provided a valve assembly including:

a valve body defining a main passage having an inlet and an outlet, the body having a valve seat;

a valve member for opening and closing the passage, the valve member being movable relative to the body between open and closed positions, in the closed position the valve member sealing against the valve seat;

an actuator assembly for moving the valve member between the open and closed positions, the actuator assembly including a shaft movable relative to the body and connected to the valve member, and at least two primary pressure chambers, the primary chambers each being divided into a relatively high-pressure chamber and a relatively low-pressure chamber by movable sealing means, the sealing means being connected to the shaft, the arrangement being such that pressurisation of the relatively high-pressure chambers moves the valve member towards either the open or the closed position.

Further according to the invention, the inlet and the outlet are aligned.

The valve body may be elongate and tubular and the valve may be a relatively high-pressure, relatively high flow-rate, large capacity, in-line valve.

Alternatively the valve may be a relatively high-pressure, relatively high flow-rate, large capacity, globe-type valve.

Further according to the invention the actuator assembly is disposed inside the valve body.

Further according to the invention, the valve assembly includes a secondary passage extending between the relatively high-pressure chambers and the inlet of the main passage; and a pilot control valve for selectively opening and closing the secondary passage to selectively pressurising the relatively high-pressure chambers. The arrangement may be further such that, by pressurising the relatively high-pressure chambers, the sealing means and thus the shaft and the valve member are displaced towards the closed position.

The movable sealing means may comprise a diaphragm disposed in each primary chamber. It will be appreciated that the actuator assembly may alternatively include at least two piston and cylinder assemblies and that the movable sealing means may in such case comprise the pistons.

Each diaphragm may be trapped between two discs that are connected to the shaft.

The primary chambers may be defined by a central disc member fixed to the inside of the valve body and two separate end disc members disposed on opposite sides of the central disc member.

The central disc member may have a central opening for receiving the shaft.

The central disc member may be fixed to the inner walls of the valve body to extend co-actually therewith, by a plurality of radially outwardly extending vanes. The secondary passage may extend along the inside of one of the vanes.

The end disc members may also each have a central hole for receiving the shaft and may be connected to the central disc member by a plurality of screws.

The outer periphery of the diaphragms may be trapped between the end disc members and the central disc member, respectively.

The relatively low-pressure chambers may be vented to a. relatively low-pressure zone such as atmosphere or downstream from the valve member.

Sealing arrangements may be disposed between the holes in the central and end disc members and the shaft.

The valve body may define connecting formations towards opposite ends for connecting the valve assembly in-line with a pipeline.

The valve body may be collapsible inwardly along its longitudinal axis to facilitate the installation and/or removal of the valve assembly in-line with a pipeline.

The valve member may have a pointed configuration in the upstream direction.

The combined surface area of the movable sealing means in the high-pressure chambers may be relatively larger than the upstream facing surface area of the valve member.

The shaft may comprise three lengths that are connected end to end.

### BRIEF DESCRIPTION OF THE DRAWINGS

The invention will now be described by way of non-limiting examples with reference to the accompanying drawings wherein:

FIG. 1 is a longitudinal-sectional side view of a valve assembly according to a first embodiment of the invention, in an open condition;

FIG. 2 is the same view as that of FIG. 1, with the valve assembly shown in a closed condition;

FIG. 3 is a cross-sectional end view along line A-A¹ in FIG. 1;

FIG. 4 is a longitudinal-sectional side view of an in-line valve assembly according to a second embodiment of the invention in an open condition;

FIG. 5 is a longitudinal-sectional side view of an in-line valve assembly according to a third embodiment of the invention in an open condition;

FIG. 6 is a longitudinal-sectional side view of a valve assembly according to a fourth embodiment of the invention in a closed condition;

FIG. 7 is a longitudinal-sectional side view of a valve assembly according to a fifth embodiment of the invention in an open condition; and

FIG. 8 is the same view as that of FIG. 7, with the valve assembly in a closed condition.

In the drawings, similar or same components are designated with the same numbers.

### DESCRIPTION OF PREFERRED EMBODIMENTS OF THE INVENTION

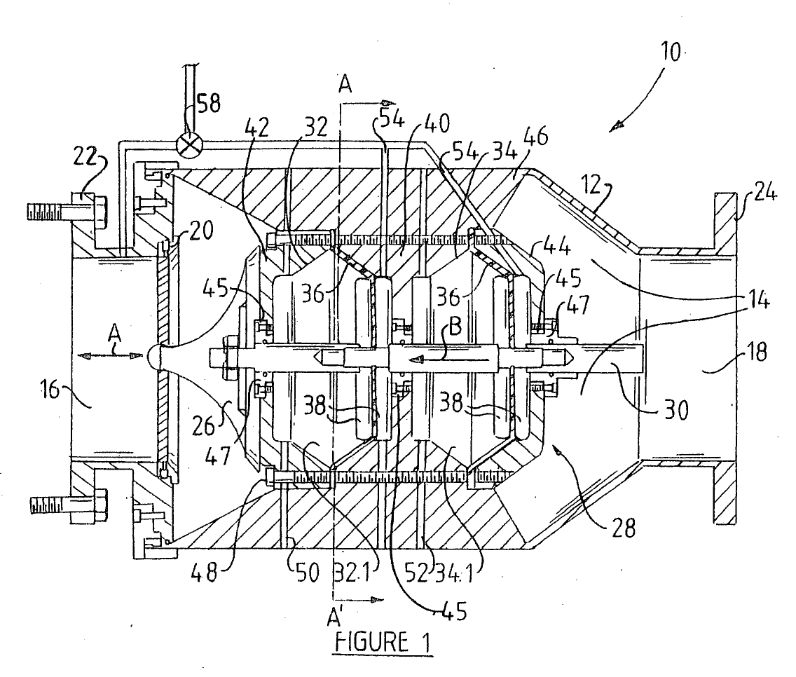

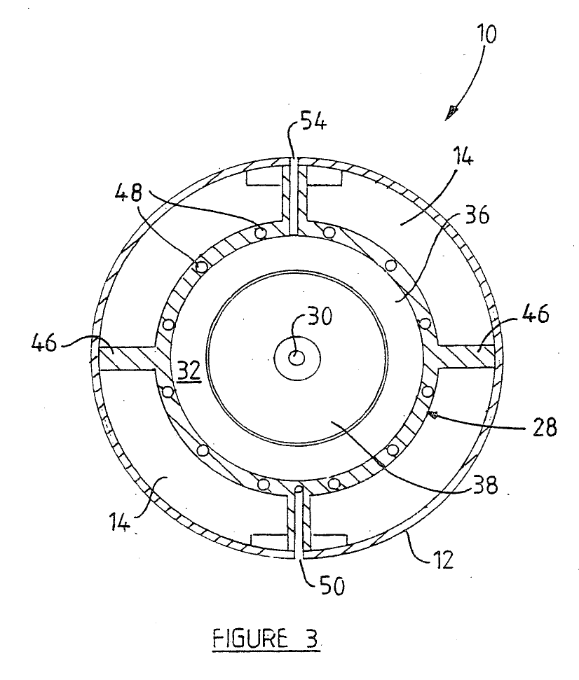

Referring to FIGS. 1 to 3, a relatively high-pressure, relatively high flow-rate, large capacity, in-line valve assembly according to a preferred embodiment of the invention, is generally designated by reference numeral 10. The valve assembly 10 is particularly suitable for regulating liquid flow along high-pressure primary and secondary liquid supply lines (not shown). However, a valve assembly according to the invention can be used in a wide range of applications.

The valve assembly 10 includes a tubular elongate valve body 12 defining a passage 14 having an inlet 16 and an outlet 18, the inlet 16 and the outlet 18 being aligned. The body 12 further defines an annular valve seat 20. Opposite ends of the valve body 12 provides annular flange formations 22 and 24, for installation of the valve assembly 10 in line with a water supply pipe (not shown). The valve body 12 is collapsible inwardly along its longitudinal axis to facilitate the installation and/or removal of the valve assembly in-line with a pipeline.

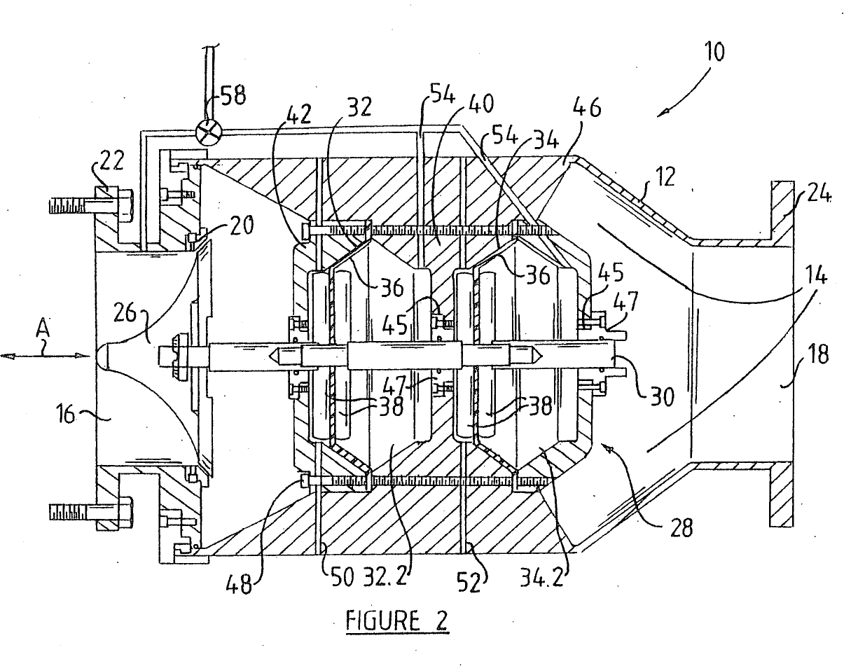

The valve assembly 10 further includes a valve member 26 for closing the passage 14. The valve member 26 is pointed in the upstream direction indicated by arrow B in FIG. 1. The valve member 26 is movable as indicated by arrows A between an open position (shown in FIG. 1) and a closed position (shown in FIG. 2). In the closed position, the valve member 26 seals against the valve seat 20.

The valve assembly 10 further includes an actuator assembly, generally designated by reference numeral 28, for moving the valve member 26 between the open and closed positions. The actuator assembly 28 includes an elongate central shaft 30 connected to the valve member 26, a central disc member 40, and two end disc members 42 and 44 connected to opposite ends of the central disc member 40 by screws 48. The central disc member 40 is fixed to the inner wall of the valve body 12 by radially outwardly extending vanes 46.

The disc members 40 to 44 collectively define two main pressure chambers 32 and 34. The main pressure chambers 32 and 34 are each divided by a movable sealing means into a relatively low-pressure chamber 32.1 and 34.1 (shown in FIG. 1) and a relatively high-pressure chamber 32.2 and 34.2 (shown in FIG. 2). The sealing means. comprises a flexible diaphragm 36. A central region of each diaphragm 36 is trapped and sealed between two locking discs 38, which are connected to the shaft 30. The outer periphery of each diaphragm 36 is trapped and sealed between the central disc member 40 and the end disc members 42 and 44, respectively.

The disc members 40 to 44 each define a central hole 45 for slidably receiving the shaft 30 as well as a bearing with a seal arrangement 47, which is disposed in each hole for sealing against the shaft 30. The shaft 30 comprises three portions, which screw to each other in end to end relationship, to facilitate installation of the diaphragms 36 and locking discs 38.

The relatively low-pressure chambers 32.1 and 34.1 are vented to a low-pressure zone such as atmosphere or down-stream of the valve member 26, via secondary passages 50 and 52. The relatively high-pressure chambers 32.2 and 34.2 are connected to a source of high-pressure via a secondary passage 54, which extends from the high-pressure chambers 32.2 and 34.2 to the inlet side of the main passage 14. A three-way pilot control valve 58 is disposed in the secondary passage 54. The secondary passages 50, 52 and 54 extend along the inside of the vanes 46.

In use, to close the valve assembly 10, the three-way pilot control valve 58 is opened so that high-pressure water flows along the secondary passage 54 to the high-pressure chambers 32.2 and 34.2. The drain port of the three-way pilot control valve 58 is simultaneously closed off. The high-pressure chambers 32.2 and 34.2 are pressurised and therefore expand to move the diaphragm 36 and thus the discs 38, and the shaft 30 in the direction of arrow B (FIG. 1) towards the closed position, until the valve member 26 seals against the valve seat 20. The relatively low-pressure chambers 32.1 and 34.1 are simultaneously vented to a low-pressure zone such as atmosphere or downstream from the valve member 26.

It will be appreciated that the combined surface area of the high-pressure side of the two diaphragms 36 are larger than the up-stream facing surface area of the valve member 26 and that the pressure on the inlet side of the valve member 26 is thus used to close the valve assembly 10. When the valve assembly 10 is to be opened, the three-way pilot control valve 58 is closed and the high-pressure chambers 32.2 and 34.2 vented to a low-pressure zone via the valve 58.

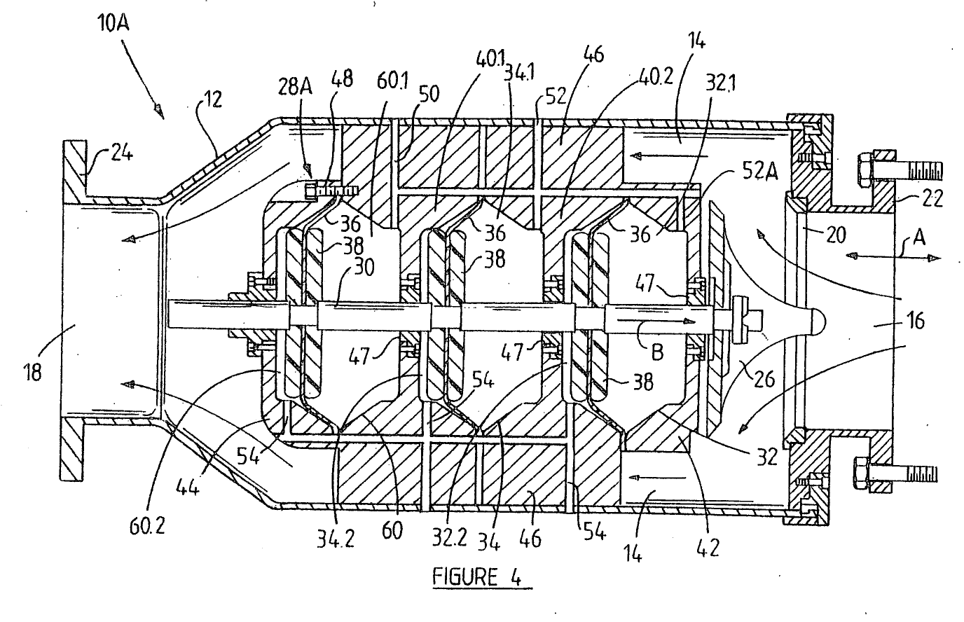

Referring to FIG. 4, an in-line valve assembly according to a second embodiment of the invention is generally designated by reference numeral 10A. The valve assembly 10A is similar to the assembly 10, with the exception that the actuator assembly 28A of the valve assembly 10A is provided with three main chambers 32, 34 and 60, which are each divided by a diaphragm into a relatively low-pressure chamber 32.1; 34.1; and 60.1 and a relatively high-pressure chamber 32.2; 34.2; and 60.2.

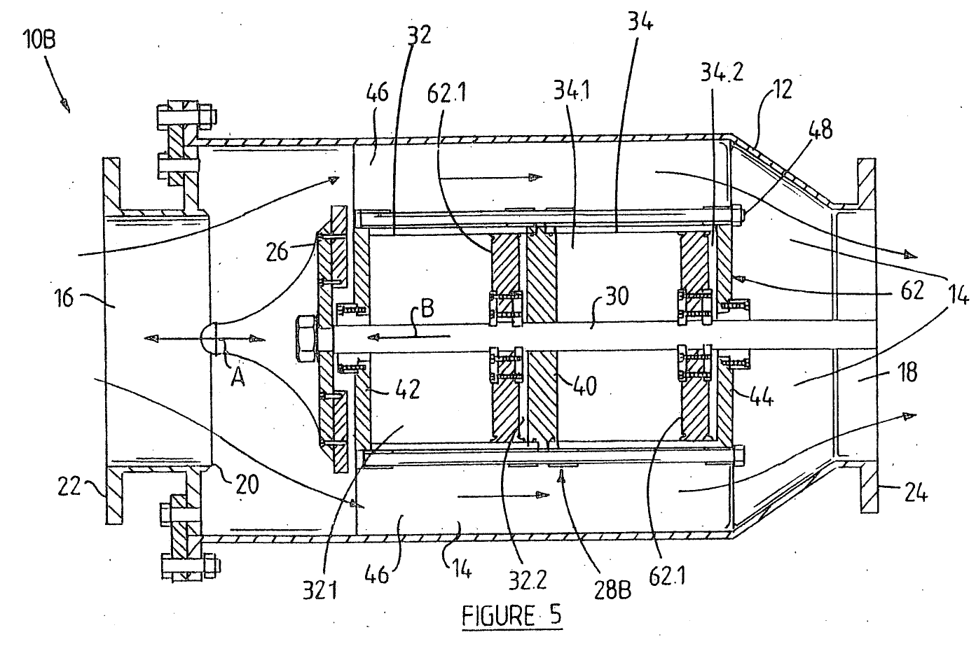

Referring to FIG. 5, an in-line valve assembly according to a third embodiment of the invention is generally designated by reference numeral 10B. The valve assembly 10B is similar to the assembly 10, with the exception that the actuator assembly 28B of the valve assembly 10B includes two piston and cylinder assemblies 62, instead of diaphragms, so that the high and low-pressure chambers are separated from each other by the pistons 62.1.

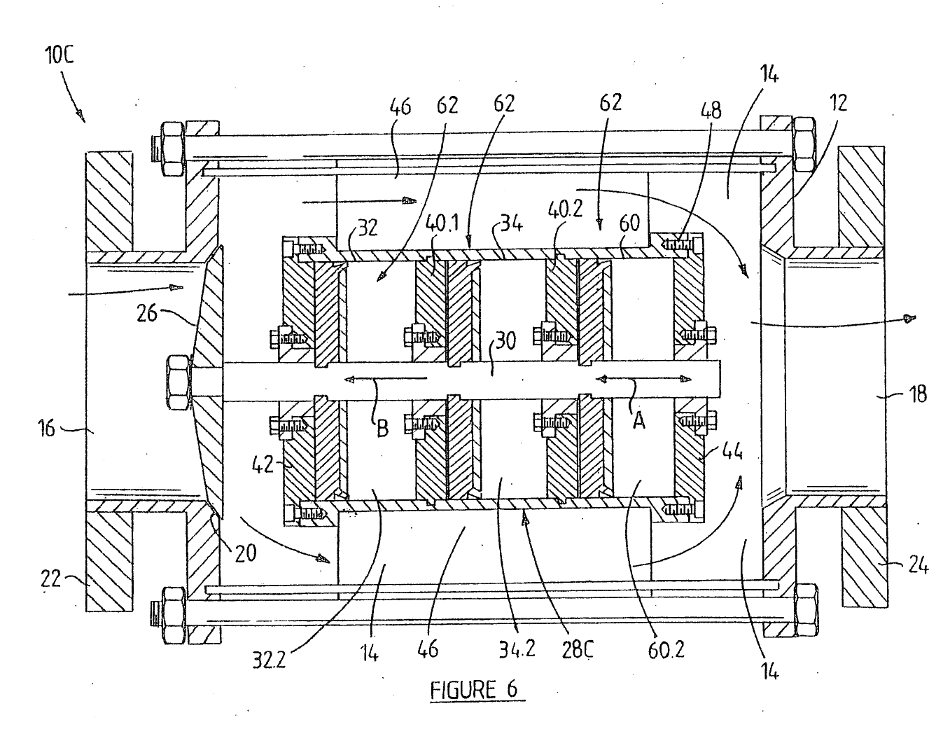

Referring to FIG. 6, an in-line valve assembly according to a fourth embodiment of the invention is generally designated by reference numeral 10C. The valve assembly 10C is similar to the assembly 10B, with the exception that the actuator assembly 28C of the valve assembly 10C comprises three piston an cylinder assemblies 62, instead of two.

It will be appreciated that the valve assemblies 10A and 10C are particularly suitable for use in applications where the inlet supply pressure when utilised for closing purposes is relatively low necessitating a large area advantage to multiply the opposing closing force to obtain a positive drop-tight closing response. It will be appreciated further that the selection of the number of main pressure chambers and their particular surface areas will enable virtually unlimited surface area ratios, which could be utilised in ratio pressure reduction applications.

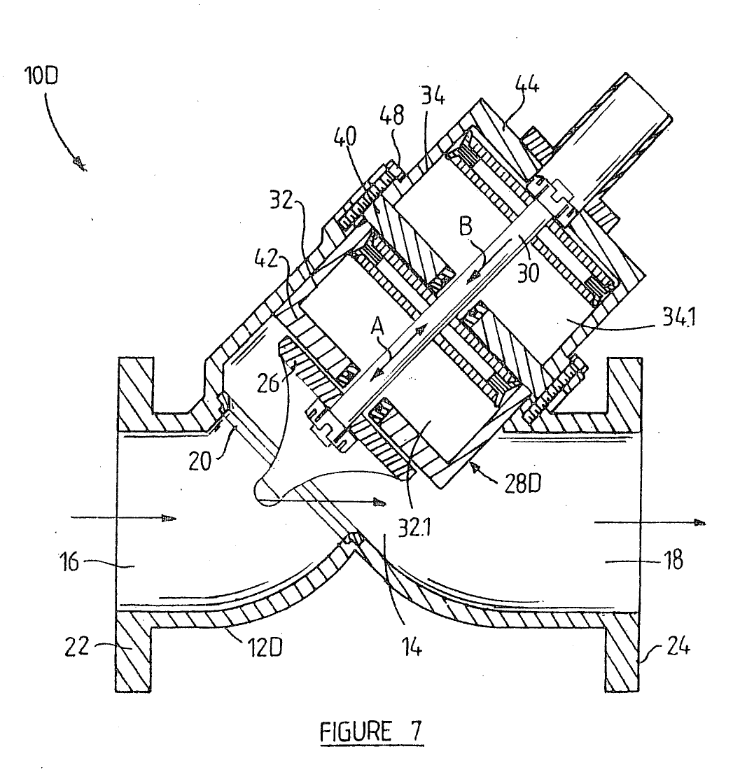

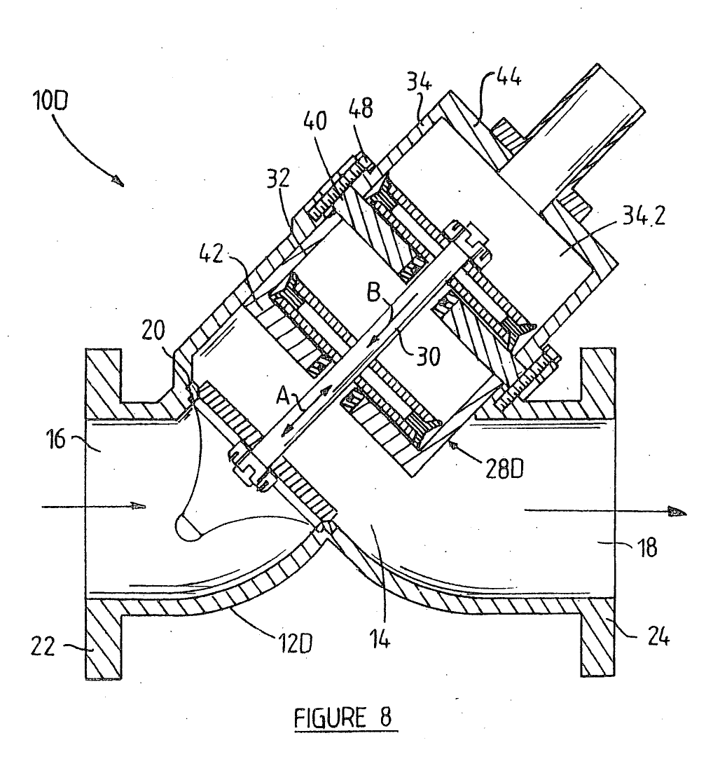

Referring to FIGS. 7 and 8, a valve assembly according to a fifth embodiment of the invention is generally designated by reference numeral 10D. The valve assembly 10D works on the same principle as the other valve assemblies described above, with the exception that the valve body 12D of the valve assembly 10D is in the form of a globe-type valve.

Because the inlets 16 and the outlets 18 of the above valve assemblies 10 to 10D are aligned, a relatively higher flow rate can be maintained through their valve bodies 12 and 12D respectively.

Furthermore, because of the configuration of the actuating assembly 28 of the above valve assemblies 10 to 10D, opening and closing thereof can be achieved in a controlled fashion. The location of the actuating assembly 28 inside the valve body further reduces the overall dimensions of the valve body, without restricting flow through the valve body.

It will be appreciated that by providing two or more main pressure chambers inside the actuator assembly, the diameter of the actuator assembly is reduced substantially, thus streamlining the main passage to optimise flow through the body. In addition, the overall diameter of the valve body is therefore reduced.

It will be appreciated further that variations in detail are possible with a valve assembly according to the invention without departing from the scope of the appended claims.

1. A relatively high-pressure, relatively high flow-rate, large capacity, valve assembly including
a valve body defining a main passage having an inlet and an outlet, the body having a valve seat;
a valve member for opening and closing the passage, the valve member being movable relative to the body between open and closed positions, in the closed position the valve member sealing against the valve seat;
an actuator assembly for moving the valve member between the open and closed positions, the actuator assembly including a shaft movable relative to the body and connected to the valve member, and at least two primary pressure chambers, the primary chambers each being divided into a relatively high-pressure chamber and a relatively low-pressure chamber by movable sealing means, the sealing means being connected to the shaft,
the arrangement being such that pressurisation of the relatively high-pressure chambers moves the valve member towards either the open or the closed position.

2. A valve assembly according to claim 1 wherein the inlet and the outlet are aligned.

3. A valve assembly according to claim 1 or claim 2 wherein the valve body is elongate and tubular and wherein the valve assembly is in the form of a relatively high-pressure, relatively high flow-rate, large capacity, in-line type valve.

4. A valve assembly according to claim 1 or claim 2 wherein the valve assembly is in the form of a relatively high-pressure, relatively high flow-rate, large capacity, globe-type valve.

5. A valve assembly according to any one of the preceding claims wherein the actuator assembly is disposed inside the valve body.

6. A valve assembly according to any one of the preceding claims which includes a secondary passage extending between the relatively high-pressure chambers and the inlet of the main passage; and a pilot control valve for selectively opening and closing the secondary passage to selectively pressurise the relatively high-pressure chambers, the arrangement being such that, by pressurising the relatively high-pressure chambers, the sealing means, and thus the shaft and the valve member are displaced towards the closed position.

7. A valve assembly according to any one of the preceding claims wherein the movable sealing means comprises a diaphragm disposed in each primary chamber.

8. A valve assembly according to claim 7 wherein each diaphragm is trapped between two discs which are connected to the shaft.

9. A valve assembly according to any one of claims 1 to 6 wherein the actuator assembly includes two piston and cylinder assemblies and wherein the movable sealing means comprises the pistons.

10. A valve assembly according to any one of the preceding claims wherein the primary chambers are defined by a central disc member fixed to the inside of the valve body and two separate end disc members disposed on opposite sides of the central disc member.

11. A valve assembly according to claim 10 wherein the central disc member is fixed to the inner walls of the valve body to extend co-actually therewith, by a plurality of radially outwardly extending vanes.

12. A valve assembly according to claim 11 wherein the secondary passage extends along the inside of one of the vanes.

13. A valve assembly according to any one of claims 10 to 12 wherein the central disc member has a central opening for receiving the shaft.

14. A valve assembly according to claim 13 wherein the end disc members each have a central hole for receiving the shaft and are connected to the central disc member by a plurality of screws.

15. A valve assembly according to any one of claims 13 and 14 wherein sealing arrangements are disposed between the holes in the central and end disc members and the shaft.

16. A valve assembly according to claim 14 insofar as it is dependant on claims 7 and 8, wherein the outer periphery of the diaphragms are trapped between the end disc members and the central disc member, respectively.

17. A valve assembly according to any one of the preceding claims wherein the relatively low-pressure chambers are vented to a relatively low-pressure zone such as atmosphere or downstream from the valve member.

18. A valve assembly according to any one of the preceding claims wherein the valve body defines connecting formations towards opposite ends for connecting the valve assembly in-line with a pipeline.

19. A valve member according to any one of the preceding claims wherein the valve member has a pointed configuration in the upstream direction.

20. A valve assembly according to any one of the preceding claims wherein the combined surface area of the movable sealing means in the high-pressure chambers are larger than the upstream facing surface area of the valve member.

21. A valve assembly according to any one of the preceding claims wherein the shaft comprises at least three lengths that are connected end to end.

22. A valve assembly according to any one of the preceding claims wherein the valve body is collapsible inwardly along its longitudinal axis to facilitate the installation and/or removal of the valve assembly in-line with a pipeline.

23. A valve assembly substantially as herein described an as illustrated in the accompanying drawings.
